(19) United States
(12) Patent Application Publication
(10) Pub. No.: US 2014/0064079 A1
(43) Pub. Date: Mar. 6, 2014

(54) ADAPTIVE CONGESTION MANAGEMENT

(71) Applicant: Broadcom Corporation, Irvine, CA (US)

(72) Inventors: Bruce KWAN, Sunnyvale, CA (US); Puneet AGARWAL, Cupertino, CA (US)

(21) Appl. No.: 13/924,303

(22) Filed: Jun. 21, 2013

Related U.S. Application Data
(60) Provisional application No. 61/695,265, filed on Aug. 30, 2012.

(51) Int. Cl. H04L 12/801

(52) U.S. Cl. CPC H04L 47/12
USPC 370/234

(57) ABSTRACT

A computer-implemented method for implementing a congestion management policy, the method including, determining a minimum congestion state for a first queue, based on a minimum guarantee use count of the first queue, determining a shared congestion state for the first queue, based on a shared buffer use count and a shared buffer congestion threshold, wherein the shared buffer congestion threshold is further based on an amount of remaining buffer memory and determining a global congestion state based on a global shared buffer use count. In certain aspects, the method further includes implementing a congestion management policy based on the minimum congestion state, the shared congestion state and the global congestion state. Systems and computer-readable media are also provided.

This application claims the benefit of U.S. Provisional Application No. 61/695,265, filed Aug. 30, 2012, entitled “ADAPTIVE CONGESTION MANAGEMENT,” which is incorporated herein by reference.

### BACKGROUND

Conventional DCTCP implementations can be used to provide packet marking for notification of congestion events. Such implementations are often based on predefined static thresholds relating to a buffer fill level of a network switch, wherein packets are aggressively marked to provide an explicit congestion notification (ECN) when congestion is detected (e.g., when a buffer fill level exceeds a static threshold). Based on the congestion notification, a transmission window size (e.g., for a server transacting data), is reduced to avoid packet loss. Congestion detection can trigger significant reductions in the transmission window size, for example, by as much as 50%.

Although conventional congestion management implementations (such as DCTCP) can improve data throughput, in some congestion scenarios conventional marking policies can hamper performance. For example, in cases where congestion is momentary (e.g., an incast event) and adequate buffer resources are available, it can be beneficial to allow congested queues to clear without ECN marking

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIG. 1 illustrates an example of a network system, with which certain aspects of the subject technology can be implemented.

FIG. 2 illustrates an example of a queue used to receive and buffer transmission packets, according to certain aspects of the subject disclosure.

FIG. 3 illustrates an example of a global shared buffer that can be implemented in a shared memory switch, according to certain aspects of the disclosure.

FIG. 4 illustrates a flow diagram for an example marking policy, according to certain aspects of the disclosure.

FIG. 5 illustrates a table of an example marking policy, according to certain aspects of the disclosure.

FIG. 6 illustrates an example of an electronic system that can be used to implement certain aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

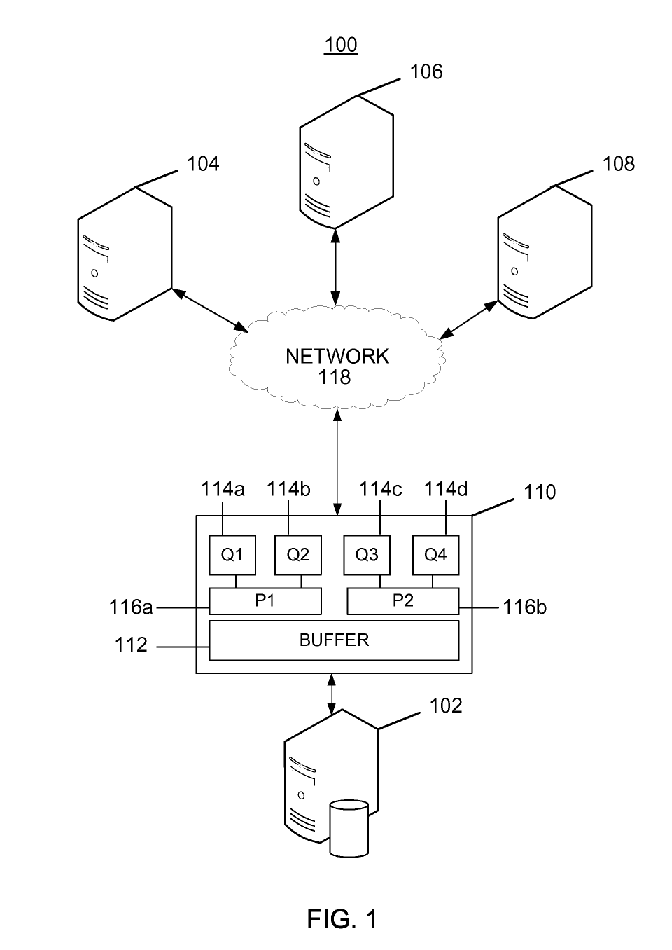

The subject disclosure relates to a flexible marking policy that can be used to mark data packets in order to indicate a state of network congestion. In certain aspects the marking policy can be implemented in a shared memory switch, such as switch 110 in the example of FIG. 1. When marking is implemented to indicate network congestion, a transmission window size of one or more computers in the network (e.g., network 118) is reduced to decrease the rate at which new data is transmitted, in order to alleviate network congestion.

In conventional packet marking implementations, indications of network congestion can cause the transmission window size for a computing device to be significantly reduced. However, depending on conditions of the shared memory switch (e.g., congestion states of one or more queues, ports and/or global buffers), significant reductions in the transmission window size may not be necessary and can cause losses in performance.

To address the problems associated with unnecessary packet marking, the subject disclosure provides a flexible marking policy that is based on dynamic attributes of a shared memory switch. That is, implementations of the subject disclosure provide for flexible marking policies that can change with respect to the changing congestion conditions of one or more queues, ports and/or buffers in a shared memory switch.

Although uses of a flexible marking policy with respect to certain DCTCP applications are illustrated herein, the subject technology is not limited to DCTCP and can be implemented with other communications protocols that provide for explicit congestion notification (ECN).

In certain aspects, the subject technology provides a flexible marking policy that is tied to the dynamic attributes of a shared memory switch to ensure that packet marking is not implemented under unnecessary conditions. By avoiding unnecessary marking, the potential for unnecessarily degrading throughput (as a result of over cutting a transmission window size), can be reduced.

More specifically, the subject technology provides for flexible marking policies based on dynamic switch attributes, such as, an amount of available shared buffer space and the congestion states of one or more queues associated with the buffer. In some aspects, a flexible marking policy can be implemented on a queue-by-queue basis. However, flexible marking policies can also be implemented on other functional levels of switch operation, for example, with respect to groups of queues or ports. By providing for flexible marking policies that are adaptable to changes in available switch resources, the subject technology can provide for policies that are better adapted to network traffic fluctuations as compared to conventional DCTCP implementations.

In certain aspects, marking can be performed on a queue-by-queue basis, where marking is performed for packets associated with a particular queue based on attributes specific to the queue. By way of example, a marking policy can be implemented based on a minimum amount of buffer memory allocated to a queue (e.g., a minimum guarantee limit), an amount of shared buffer memory available to the queue and an amount of shared buffer memory that has been used by one or more other queues associated with the buffer.

As will be described in further detail below, the aforementioned attributes can be used to determine various state variables for use in implementing a flexible marking policy of the subject technology. Relevant state variables can include a Minimum Congestion State, a Shared Congestion State, a Global Congestion State and a Port Shared Congestion State. Using various state variables, a flexible marking policy (e.g., a DCTCP marking policy) can be implemented, for example, in a shared memory switch used in a network system, such as that illustrated in FIG. 1.

Specifically, FIG. 1 illustrates an example of network system 100, which can be used to implement a flexible marking policy, in accordance with one or more implementations of the subject technology. Network system 100 comprises first computing device 102, second computing device 104, third computing device 106 and fourth computing device 108. The network system 100 also includes switch 110 and network 118. Switch 110 (e.g., a shared memory switch) is depicted as comprising shared buffer 112 associated with multiple queues (e.g., Q1 114a, Q2 114b, Q3 114c and Q4 114d). Furthermore, multiple queues (114a, 114b, 114c and 114d) are variously combined to form ports P1 116a and P2 116b. Although switch 210 is depicted with four queues (114a, 114b, 114c and 114d) and two ports (P1 116a and P2 116b), a greater or lesser number of queues and/or ports could be associated with shared buffer 112.

It should be understood that the queues (e.g., Q1 114a, Q2 114b, Q3 114c and Q4 114d) do not represent physical components of switch 110, but rather represent logical units for use in queuing data packets stored to various memory portions of shared buffer 112. Additionally, although network system 100 is illustrated with four computing devices, it is understood that any number of computing devices could be communicatively connected to network 118. Furthermore, network 118 could comprise multiple networks, such as a network of networks, e.g., the Internet.

In the example of FIG. 1, first computing device 102 is communicatively coupled to second, third and fourth computing devices (104, 106 and 108) via switch 110 and network 118. One or more aspects of the subject technology can be implemented by switch 110 and/or one or more of first, second, third and fourth computing devices (102, 104, 106 and 108), over network 118. In some examples, first computing device 102 can issue multiple queries that are received by switch 110 and transmitted to each of the second, third and fourth computing devices (104, 106 and 108), via network 118. Subsequently, the second, third and fourth computing devices (104, 106 and 108), can reply by transmitting data packets back to first computing device 102, via network 118 and switch 110.

In some scenarios, the sudden influx of traffic to switch 110, e.g., from second, third and fourth computing devices (104, 106 and 108) to first computing device 102, can cause momentary congestion in switch 110 (i.e., an incast event). For some incast events, it can be advantageous to simply let the shared buffer (e.g., shared buffer 112) and the associated queues (e.g., Q1 114a, Q2 114b, Q3 114c and Q4 114d) clear, without packet marking. As discussed above, packet marking can cause a transmission window (e.g., of first computing device 102) to be significantly reduced to avoid the chance of dropping data packets. However, for some congestion events, the aggressive reduction of the transmission window size can decrease overall throughput. Thus, for such events, it can be advantageous to avoid marking altogether.

According to some aspects, switch 110 can be configured to implement a flexible marking policy for providing a congestion notification (e.g., an ECN) to first computing device 102, based on a congestion state of switch 110. In one or more embodiments, switch 110 can include storage media and processors (not shown) configured to monitor a queue bound to first computing device 102, for implementing a flexible congestion management policy based on various switch attributes. In one or more implementations, the congestion management policy will be based on multiple switch attributes, including a fill level of shared buffer 112 and a congestion state of one or more of the queues (e.g., Q1 114a, Q2 114b, Q3 114c and Q4 114d) or ports (e.g., P1 116a and P2 116b).

In one or more embodiments, a flexible marking policy can be implemented in a network switch on a queue-by-queue basis. That is, the decision to mark and/or not to mark data packets for a particular queue can be made based on the states of one or more state variables determined by attributes of the queue and shared buffer 112. In some implementations, a flexible marking policy can be implemented on a port-by-port basis, for example, based on attributes of a port that is associated with one or more queues.

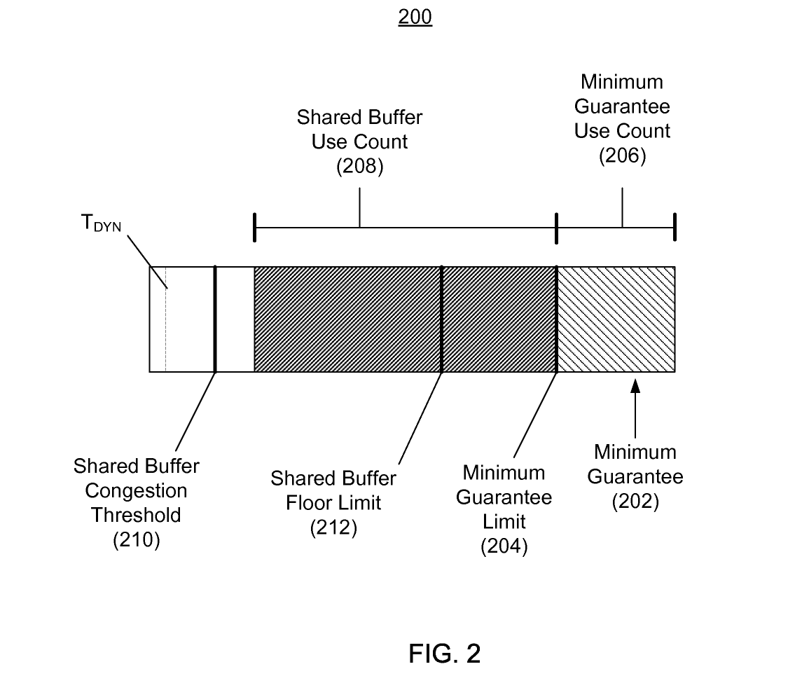

Various queue attributes are illustrated in greater detail in the example of FIG. 2. Specifically, FIG. 2 illustrates an example queue 200 that can be associated with packets received by a switch, in accordance with one or more implementations. Queue 200 can correspond with any of the queues discussed above with respect to FIG. 1 (e.g., Q1 114a, Q2 114b, Q3 114c and Q4 114d). In one or more implementations, queue 200 can comprise one of multiple queues associated with a buffer, such as shared buffer 112 in switch 110. Queue 200 may also be associated with one or more ports, such as, P1 116a and P2 116b, discussed above.

As illustrated, queue 200 includes a logical division comprising a minimum guarantee 202. Queue 200 also comprises indications of a minimum guarantee limit 204, a minimum guarantee use count 206, a shared buffer use count 208, a shared buffer congestion threshold 210 and a shared buffer floor limit 212.

The minimum guarantee 202 represents a pre-allocated portion of shared buffer memory that has been allocated to queue 200. The minimum guarantee 202 is used for buffering data packets assigned to queue 200. Similarly, other queues associated with the shared buffer memory can have respective minimum guarantee allocations in the same shared buffer. In certain aspects, the maximum amount of memory space available for the minimum guarantee of a particular queue is defined by a corresponding minimum guarantee limit.

In one or more implementations, minimum guarantee limit 204 indicates a maximum amount of buffer memory allocated to minimum guarantee 202. Additionally, minimum guarantee use count 206 indicates how much of minimum guarantee 202 has been filled with data. Thus, minimum guarantee use count 206 can either be less than minimum guarantee limit 204 (e.g., if the minimum guarantee 202 has not been completely filled), or minimum guarantee use count 206 can be equal to minimum guarantee limit 204 (e.g., if the minimum guarantee 202 has filled to capacity). Once the minimum guarantee has been filled to capacity, additional data packets that are associated with queue 200 must be stored in shared buffer memory allocated to queue 200, as discussed in further detail below.

In one or more implementations, a Minimum Congestion State variable is defined based on various attributes of queue 200, including minimum guarantee limit 204 and minimum guarantee use count 206. The Minimum Congestion State can be designated as “low” if minimum guarantee use count 206 is less than minimum guarantee limit 104. Alternatively, the Minimum Congestion State can be designated as “high” if minimum guarantee use count 206 is equal to minimum guarantee limit 204. Thus, the Minimum Congestion State yields a measure of congestion with respect to minimum guarantee 202 of queue 200.

In addition to minimum guarantee 202, queue 200 can have access to a dynamically allotted amount of shared buffer memory in the buffer (not shown). The amount of shared buffer memory allocated to queue 200 will depend on a respective queue share buffer limit for queue 200. In certain aspects, the queue shared buffer limit will be a function of the amount of remaining buffer memory (e.g., the portion of shared buffer memory not allocated to other queues in the shared memory switch). In some implementations, the queue shared buffer limit for a particular queue (e.g., queue 200) can be expressed as T_{DYN} and given by the expression:

T_{DYN}=α(B_{R}) (1)

Where a represents a user configurable scale factor (e.g., a “burst absorption factor”) and B_{R} represents an amount of globally available shared buffer memory. Thus, at any given instant, the total memory available to queue 200 is equal to the sum of minimum guarantee limit 204 and the (dynamic) queue shared buffer limit (T_{DYN}). As such, any amount of data allocated to queue 200 which exceeds the total available memory (e.g., the minimum guarantee limit 204+T_{DYN}) will be dropped from queue 200.

As further indicated in FIG. 2, the total amount of shared buffer memory that has actually been used by queue 200 is indicated by shared buffer use count 208. The shared buffer use count 208 cannot exceed the queue shared buffer limit (T_{DYN}). Another measure of memory use for queue 200 is shared buffer congestion threshold 210, which is based on the queue shared buffer limit (T_{DYN}). As will be described in further detail below, the shared buffer congestion threshold 210 can be used to determine when marking should (or should not) be implemented. In certain aspects, the shared buffer congestion threshold 210 can be given by the expression:

Shared Buffer Congestion Threshold=β(T_{DYN}) (2)

where β can be a fraction of T_{DYN}. Thus, the shared buffer congestion threshold 210 is also a function of the remaining buffer memory (B_{R}), as discussed above with respect to Equation (1).

Although, Equation (1) defines queue shared buffer limit (T_{DYN}) as a ratio of available shared buffer memory (B_{R}), it should be understood that the queue shared buffer limit can be based on any suitable function of B_{R}. Although Equation (2) defines the shared buffer congestion threshold 210 as a ratio of T_{DYN}, the shared buffer congestion threshold 210 can be calculated using other functions of T_{DYN}.

In certain aspects, shared buffer use count 208 can be compared with shared buffer congestion threshold 210, to produce a measure of the congestion state of the shared buffer memory. This comparison is represented by a “Shared Congestion State” variable, with respect to queue 200. Specifically, the Shared Congestion State can be based on a comparison of shared buffer use count 208 and shared buffer congestion threshold 210.

By way of example, the Shared Congestion State will be determined to be “low” if shared buffer use count 208 is less than shared buffer congestion threshold 210. Similarly, the Shared Congestion State will be determined to be “high” if the shared buffer use count is greater than shared buffer congestion threshold 210.

Because, the shared buffer congestion threshold can potentially be very low (or very high), for example, due to significant fluctuations in the availability of shared buffer memory, the high/low state of the Shared Congestion State variable can be further based on a shared buffer floor limit 212. The shared buffer floor limit 212 defines a minimum threshold with respect to an amount of shared buffer memory that has been used by queue 200.

In certain aspects, the Shared Congestion State will be determined to be “low” if Shared Buffer Use Count 208 is less than the maximum of the shared buffer congestion threshold 210 and the shared buffer floor limit 212, e.g., Shared Congestion State=“low”|shared buffer use count<max(shared buffer congestion threshold, shared buffer floor limit). Similarly, the Shared Congestion State will be determined to be “high” if the shared buffer use count 208 is greater than the maximum of the shared buffer congestion threshold 210 and the shared buffer floor limit 212, e.g., Shared Congestion State=“high”|shared buffer use count>max(shared buffer congestion threshold, shared buffer floor limit). Thus, the shared congestion state can give one indication of a state of congestion with respect to shared buffer memory that has been allocated to a particular queue in a global shared buffer, such as, shared buffer 112 of switch 110.

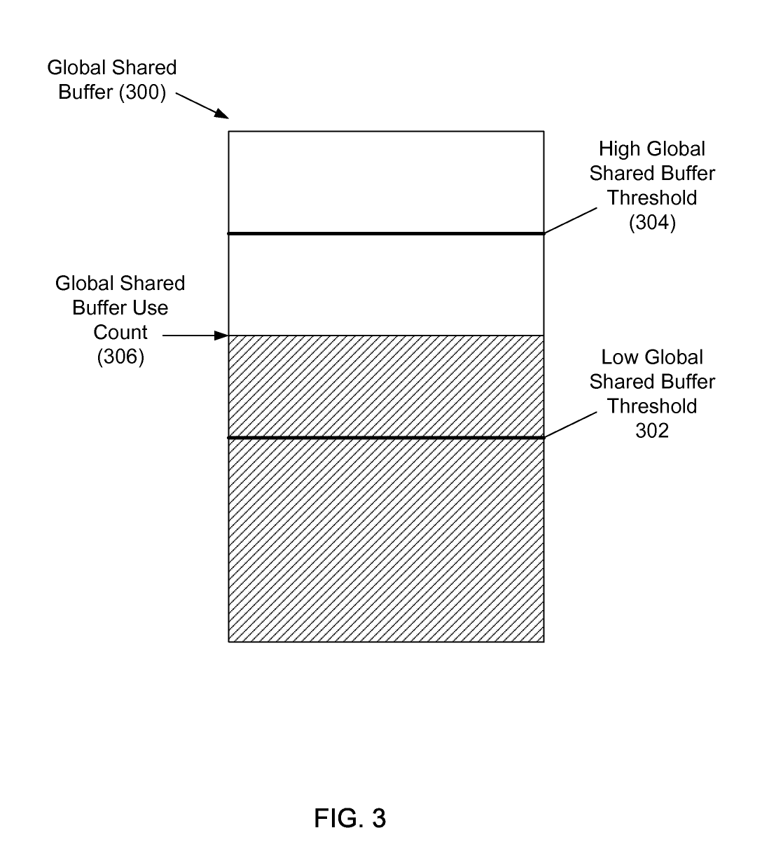

Various global shared buffer attributes are illustrated in greater detail in the example provided in FIG. 3. Specifically, FIG. 3 illustrates an example of global shared buffer 300 that can be implemented in a shared memory switch (e.g., switch 110), together with queue 200, in accordance with one or more implementations.

As illustrated, global shared buffer 300 includes an indication of a low global shared buffer threshold 302, a high global shared buffer threshold 304 and a global shared buffer use count 306.

Global shared buffer use count 306 represents a total amount of global shared buffer 300 that is used, for example, by queues of a shared memory switch. A Global Congestion State variable can be determined based on a comparison of global shared buffer use count 306 with low global shared buffer threshold 302 and high global shared buffer threshold 304. In one or more embodiments, the Global Congestion State variable will be determined to be “low” if global shared buffer use count 306 is less than low global shared buffer threshold 302. The Global Congestion State will be determined to be “medium” if global shared buffer use count 306 is greater than low global shared buffer threshold 302, and less than high global shared buffer threshold 304. Finally, the Global Congestion State variable will be determined to be “high” if global shared buffer use count 306 is greater than high global shared buffer threshold 304.

As will be described in further detail below, a flexible marking policy can be implemented that is based on the foregoing state variables (e.g., the Minimum Congestion State, the Shared Congestion State and the Global Congestion State). Because each of the state variables can change in response fluctuations in buffer congestion and/or memory allocations to one or more queues, the flexible marking policy of the subject disclosure is adaptable to the changing attributes of a shared memory switch.

In certain aspects, the combination of states of the state variable (e.g., the Minimum Congestion State, the Shared Congestion State and the Global Congestion State) can be used to determine when packet marking should be performed.

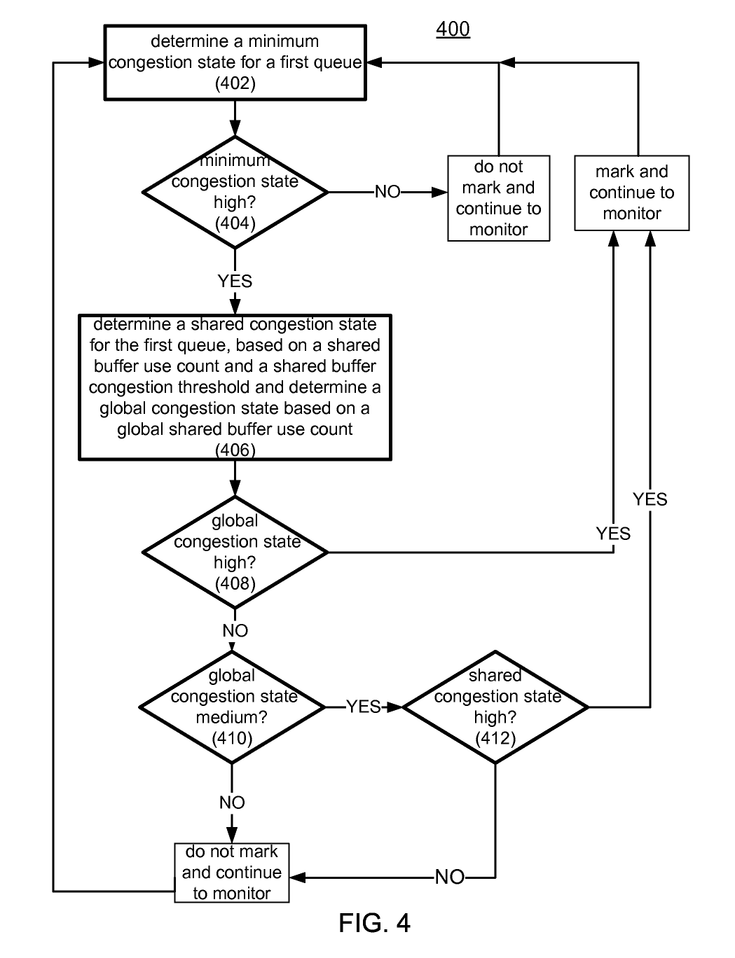

An example of a flow diagram for implementing a congestion management policy in accordance with the foregoing state variables is illustrated in FIG. 4. Specifically, flow diagram 400 illustrates a process for implementing a congestion management policy based on the Minimum Congestion State, the Shared Congestion State and the Global Congestion State, in accordance with one or more implementations. Although the process of flow diagram 400 is presented in a particular manner, it is understood that the individual processes are provided to illustrate some potential embodiments of the subject technology. In one or more other implementations, additional (or fewer) processes may be performed in a different order, to carry out various aspects of the subject technology.

Flow diagram 400 begins when a Minimum Congestion State for a first queue is determined, based on a minimum guarantee use count of the first queue (402). As discussed above with respect to FIG. 2, the Minimum Congestion State can be determined to be “low” if the minimum guarantee use count is less than a minimum guarantee limit. Similarly, the Minimum Congestion State can be determined to be “high” if the minimum guarantee is full, i.e., the minimum guarantee use count is equal to the minimum guarantee limit.

It is then determined whether or not the Minimum Congestion State is “high” or “low” (404). According to some aspects, marking will not be implemented when it is determined that the (queue) minimum congestion state is “low” (e.g., that the minimum guarantee of a queue has not yet reached capacity and minimum space is still available). In such cases, the Global Congestion State and Shared Congestion state variables may indicate that the switch is congested, however, in cases where the queue has not reached capacity, the probability of packet dropping can still be quite low. Thus, marking in such scenarios can cause over aggressive reductions in transmission window length, leading to a decrease in throughput and work quality. This scenario is illustrated wherein a determination that the minimum congestion state is “low” leads to a decision not to mark (404). As depicted, if marking is not implemented, changes in the state variables can continue to be monitored, and it will again be determined whether or not the Minimum Congestion State is “high” or “low” (404).

Alternatively, if it is determined that the Minimum Congestion State is “high,” a Shared Congestion State for the first queue is determined, based on a shared buffer use count and a shared buffer congestion threshold (406). As discussed above with respect to FIG. 2, the shared buffer congestion threshold can be calculated as a function of the amount of available (remaining) shared buffer memory. Because the amount of available shared buffer memory will change based on the shared buffer limit for each of the queues sharing the buffer, the shared buffer congestion threshold for any given queue can change as a function of traffic congestion with respect to other queues in the shared memory switch.

A Global Congestion State is also determined, based on a global shared buffer use count (406). As discussed above with respect to FIG. 3, in certain aspects, the Global Congestion State can have either a “high,” “medium,” or “low” state, depending on the respective low global shared buffer threshold, high global shared buffer threshold and the global shared buffer use count.

Next, it is decided if the Global Congestion State is “high” (408). As illustrated, if the Global Congestion State is “high,” marking is implemented and monitoring of various state variables is continued. Subsequently, a Minimum Congestion State for the first queue is again determined based on a minimum guarantee use count of the first queue (402).

Alternatively, if the Global Congestion State is “low,” it is then decided if the Global Congestion State is “medium” (410). As illustrated above with respect to FIG. 3, a “medium” Global Congestion State occurs when global shared buffer use count 306 is less than high global shared buffer threshold 304, but greater than low global shared buffer threshold 302.

If the Global Congestion State is decided to be “medium,” it is decided whether the Shared Congestion State “high” (412). If the Shared Congestion State is “high,” marking is implemented and a Minimum Congestion State for the first queue is again determined based on a minimum guarantee use count of the first queue (402). Alternatively, if the Shared Congestion State is “low,” marking is not implemented and the Minimum Congestion State for the first queue is again determined (402). Similarly, if the Global Congestion State is determined to not be “medium,” it can be inferred that the Global Congestion State is “low” and marking will not be implemented; subsequently, the Minimum Congestion State for the first queue is again determined (402).

Using the processes of flow diagram 400, a flexible congestion management policy is implemented based on the Minimum Congestion State, the Shared Congestion State and the Global Congestion State. Thus, the decision to mark/not to mark data packets can be used to indicate network congestion based on the dynamic conditions of the shared memory switch. As discussed above, although the congestion management policy can be implemented with any communication protocol that allows for ECN, in some implementations the policy will be used to provide a more flexible marking policy with respect to DCTCP.

Furthermore, the congestion management policy can be further based on a state variable that takes into consideration the shared congestion state for one or more queues that have been grouped into one or more ports. By way of example, a Port Shared Congestion State variable can be based on a port shared buffer use count and a port shared buffer congestion threshold. In some aspects, the port shared buffer use count can be calculated by adding the shared buffer use counts, e.g., for each queue associated with the port. Thus, the Port Shared Congestion State variable can be a function of the Shared Congestion State for each queue associated with a given port.

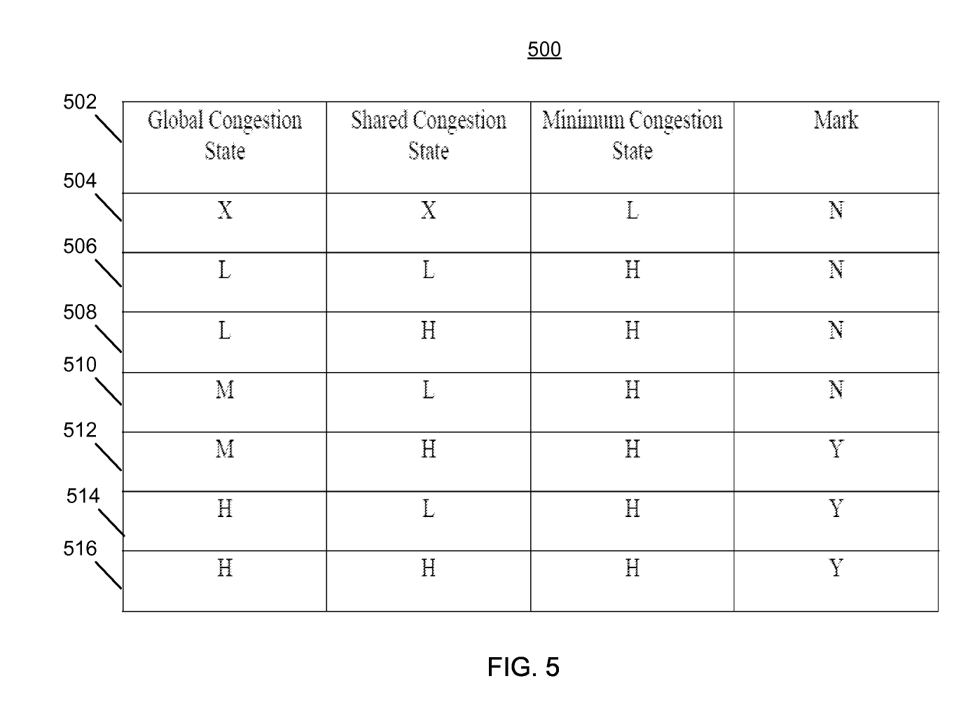

FIG. 5 illustrates a table 500 of an example marking policy, as illustrated above with respect to flow diagram 400. Specifically, table 500 comprises row 502, denoting examples of various state variables, as well as rows 504-516 that indicate a state of the respective state variables. The marking policy of table 500 is based on a Minimum Congestion State and a Shared Congestion State, with respect to a queue. Additionally, the example marking policy of FIG. 5 is based on a Global Congestion State for a shared buffer memory (e.g., the global shared buffer 300 of FIG. 3).

Row 504 illustrates a scenario wherein the Minimum Congestion State is determined to be “low.” As illustrated, “don't care” conditions are indicated for the Global Congestion State and the Shared Congestion State, and marking is not implemented. This scenario corresponds with the decision made in 404 discussed above with respect to FIG. 4.

By way of further example, queue 200 of FIG. 2 illustrates a scenario wherein minimum guarantee use count 206 is equal to minimum guarantee limit 204 and therefore the Minimum Congestion State is “high.” As further illustrated, shared buffer use count 208 is between shared buffer floor limit 212 and shared buffer congestion threshold 210. As such, the Shared Congestion State is “low.” Furthermore, with respect to FIG. 2, global shared buffer use count 206 is less than high global shared buffer threshold 204 and greater than low global shared buffer threshold 202, therefore, the Global Congestion State for global shared buffer 200 is “medium.” As shown in the example policy of FIG. 5, the foregoing examples of FIGS. 2 and 3 would correspond to row 512 of table 500.

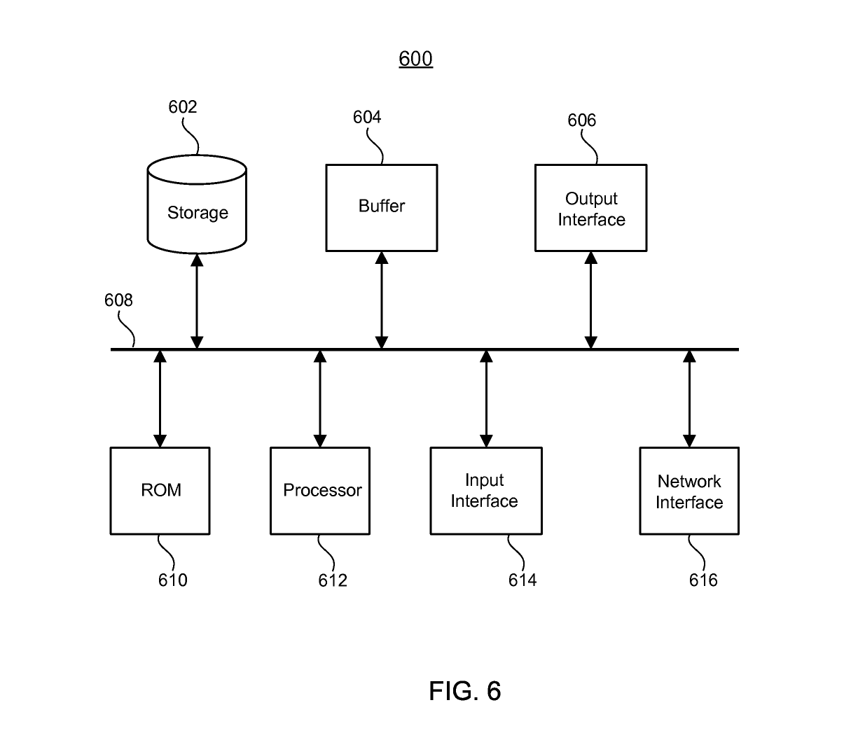

FIG. 6 illustrates an example of an electronic system 600 that can be used for executing processes of the subject disclosure, in accordance with one or more implementations. Electronic system 600, for example, can be a desktop computer, a laptop computer, a tablet computer, a server, a switch, a router, a base station, a receiver, any device that can be configured to implement a packet marking policy, or generally any electronic device that transmits signals over a network. Such an electronic system includes various types of computer readable media and interfaces for various other types of computer readable media. Electronic system 600 includes bus 608, processor(s) 612, buffer 604, read-only memory (ROM) 610, permanent storage device 602, input interface 614, output interface 606, and network interface 616, or subsets and variations thereof.

Bus 608 collectively represents all system, peripheral, and chipset buses that connect the numerous internal devices of electronic system 600. In one or more implementations, bus 608 communicatively connects processor(s) 612 with ROM 610, buffer 604, output interface 606 and permanent storage device 602. From these various memory units, processor(s) 612 retrieve instructions to execute and data to process in order to execute the processes of the subject disclosure. Processor(s) 612 can be a single processor or a multi-core processor in different implementations.

ROM 610 stores static data and instructions that are needed by processor(s) 612 and other modules of electronic system 600. Permanent storage device 602, on the other hand, is a read-and-write memory device. This device is a non-volatile memory unit that stores instructions and data even when electronic system 600 is off. One or more implementations of the subject disclosure use a mass-storage device (such as a magnetic or optical disk and its corresponding disk drive) as permanent storage device 602.

Other implementations can use one or more removable storage devices (e.g., magnetic or solid state drives) as permanent storage device 602. Like permanent storage device 602, buffer 604 is a read-and-write memory device. However, unlike permanent storage device 602, buffer 604 is a volatile read-and-write memory, such as random access memory. Buffer 604 can store any of the instructions and data that processor(s) 612 need at runtime. In one or more implementations, the processes of the subject disclosure are stored in buffer 604, permanent storage device 602, and/or ROM 610. From these various memory units, processor(s) 612 retrieve instructions to execute and data to process in order to execute the processes of one or more implementations.

Bus 608 also connects to input interface 614 and output interface 606. Input interface 614 enables a user to communicate information and select commands to electronic system 600. Input devices used with input interface 614 can include alphanumeric keyboards and pointing devices (also called “cursor control devices”) and/or wireless devices such as wireless keyboards, wireless pointing devices, etc. Output interface 606 enables the output of information from electronic system 600, for example, to a separate processor-based system or electronic device.

Finally, as shown in FIG. 6, bus 608 also couples electronic system 600 to a network (not shown) through network interface 616. It should be understood that network interface 616 can be either wired, optical or wireless and can comprise one or more antennas and transceivers. In this manner, electronic system 600 can be a part of a network of computers, such as a local area network (“LAN”), a wide area network (“WAN”), or a network of networks, such as the Internet (e.g., network 118, discussed above).

Certain methods of the subject technology may be carried out on electronic system 600. In some aspects, methods of the subject technology may be implemented by hardware and firmware of electronic system 600, for example, using one or more application specific integrated circuits (ASICs). Instructions for performing one or more steps of the present disclosure may also be stored on one or more memory devices such as permanent storage device 602, buffer 604 and/or ROM 610.

In one or more implementations, processor(s) 612 can be configured to perform operations for determining a minimum congestion state for a first queue, based on a minimum guarantee use count of the first queue and determining a shared congestion state for the first queue, based on a shared buffer use count and a shared buffer congestion threshold, wherein the shared buffer congestion threshold based on an amount of remaining buffer memory. In one or more implementations, processor(s) 612 can also be configured to perform operations for determining a global congestion state based on a global shared buffer use count and to implement a congestion management policy based on the minimum congestion state, the shared congestion state and the global congestion state.

The congestion management policy can be used to determine when to mark packets transacted through electronic system 600 (such as a shared memory switch) to provide an explicit congestion notice (ECN) to one or more servers, such as first computing device 102, discussed above with respect to FIG. 1.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessors or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for implementing a congestion management policy, the method comprising:
determining a minimum congestion state for a first queue, based on a minimum guarantee use count of the first queue;
determining a shared congestion state for the first queue, based on a shared buffer use count and a shared buffer congestion threshold, wherein the shared buffer congestion threshold is based on an amount of remaining buffer memory;
determining a global congestion state based on a global shared buffer use count; and
implementing a congestion management policy based on the minimum congestion state, the shared congestion state and the global congestion state.

2. The method of claim 1, further comprising:
determining a port congestion state based on a port shared buffer use count, wherein the port shared buffer use count is based on the shared buffer use count for the first queue and a shared buffer use count for a second queue; and
wherein the congestion management policy is further based on the port congestion state.

3. The method of claim 1, wherein the minimum congestion state is determined to be low if the minimum guarantee use count is less than a minimum guarantee limit, and
wherein the minimum congestion state is determined to be high if the minimum guarantee use count is equal to the minimum guarantee limit.

4. The method of claim 3, wherein the congestion management policy does not carry out explicit congestion notification (ECN) marking if the minimum congestion state is determined to be low.

5. The method of claim 1, wherein the shared congestion state is determined to be low if the shared buffer use count is less than the shared buffer congestion threshold, and
wherein the shared congestion state is determined to be high if the shared buffer use count is greater than the shared buffer congestion threshold.

6. The method of claim 1, wherein the shared buffer congestion threshold is based on a user configurable burst absorption factor.

7. The method of claim 1, wherein the congestion management policy is used for marking one or more data packets to indicate an explicit congestion notification (ECN).

8. The method of claim 1, wherein the congestion management policy is implemented with a data center transmission control protocol (DCTCP).

9. A system for implementing a congestion management policy, the system comprising:
one or more processors; and
a computer-readable medium comprising instructions stored therein, which when executed by the processors, cause the processors to perform operations comprising:
determining a minimum congestion state for a first queue, based on a minimum guarantee use count;
determining a shared congestion state for the first queue, based on a shared buffer use count, a shared buffer floor limit and a shared buffer congestion threshold, wherein the shared buffer congestion threshold is based on an amount of remaining buffer memory;
determining a global congestion state based on a global shared buffer use count; and
implementing a congestion management policy based on the minimum congestion state, the shared congestion state and the global congestion state.

10. The system of claim 9, further comprising:
determining a port congestion state based on a port shared buffer use count, wherein the port shared buffer use count is based on the shared buffer use count for the first queue and a shared buffer use count for a second queue; and
wherein the congestion management policy is further based on the port congestion state.

11. The system of claim 9, wherein the minimum congestion state is determined to be low if the minimum guarantee use count is less than a minimum guarantee limit, and
wherein the minimum congestion state is determined to be high if the minimum guarantee use count is equal to the minimum guarantee limit.

12. The system of claim 11, wherein the congestion management policy does not carry out explicit congestion notification (ECN) marking if the minimum congestion state is determined to be low.

13. The system of claim 9, wherein the shared congestion state is determined to be low if the shared buffer use count is less than the shared buffer congestion threshold, and
wherein the shared congestion state is determined to be high if the shared buffer use count is greater than the shared buffer congestion threshold and the shared buffer floor limit.

14. The system of claim 9, wherein the shared buffer congestion threshold is based on a user configurable burst absorption factor.

15. The system of claim 9, wherein the congestion management policy is used for marking one or more data packets to indicate an explicit congestion notification (ECN).

16. The system of claim 9, wherein the congestion management policy is implemented with a data center transmission control protocol (DCTCP).

17. A computer-readable medium comprising instructions stored thereon, which when executed by a processor, cause the processor to perform operations comprising:
determining a minimum congestion state for a first queue, based on a minimum guarantee use count of the first queue and a minimum guarantee limit of the first queue;
determining a shared congestion state for the first queue, based on a shared buffer use count, a shared buffer floor limit and a shared buffer congestion threshold, wherein the shared buffer congestion threshold is based on an amount of remaining buffer memory;
determining a global congestion state based on a global shared buffer use count; and
implementing a congestion management policy based on the minimum congestion state, the shared congestion state and the global congestion state.

18. The computer-readable medium of claim 17, further comprising:
determining a port congestion state based on a port shared buffer use count, wherein the port shared buffer use count is based on the shared buffer use count for the first queue and a shared buffer use count for a second queue; and
wherein the congestion management policy is further based on the port congestion state.

19. The computer-readable medium of claim 17, wherein the minimum congestion state is determined to be low if the minimum guarantee use count is less than the minimum guarantee limit, and
wherein the minimum congestion state is determined to be high if the minimum guarantee use count is equal to the minimum guarantee limit.

20. The computer-readable medium of claim 17, wherein the congestion management policy is used for marking one or more data packets to indicate an explicit congestion notification (ECN).
